(19) United States
(12) Patent Application Publication
(10) Pub. No.: US 2016/0263743 A1
(43) Pub. Date: Sep. 15, 2016

(54) CONVEYING ROBOT

(71) Applicant: JTEKT CORPORATION, Osaka-shi, Osaka (JP)

(72) Inventors: Chiaki TOKAI, Okazaki-shi (JP); Minetaka GOTO, Kiyosu-shi (JP); Takeshi OSUKA, Toyokawa-shi (JP)

(73) Assignee: JTEKT CORPORATION, Osaka-shi, Osaka (JP)

(21) Appl. No.: 15/035,961

(22) PCT Filed: Oct. 23, 2014
(86) PCT No.: PCT/JP2014/078159

§ 371 Date: May 11, 2016

(30) Foreign Application Priority Data
Nov. 19, 2013 (JP) 2013-239057
May 15, 2014 (JP) 2014-101229

(51) Int. Cl. B25J 9/10; B25J 5/02

(52) U.S. Cl. CPC B25J 9/107; B25J 5/02; Y10S 901/01

(57) ABSTRACT

A conveying robot is provided which can have a reduced maximum height and which can convey an object fast and stably. A conveying robot has at least one of a characteristic that a first driven link that configures the conveying robot is formed to have a bent shape that protrudes toward a second driven link with respect to a straight line that connects a first intermediate rotation support and a first tip-side rotation support, and a characteristic that the second driven link is formed to have a bent shape that protrudes toward the first driven link with respect to a straight line that connects a second intermediate rotation support and a second tip-side rotation support.

### TECHNICAL FIELD

The present invention relates to a conveying robot that can convey an object in an up-down direction while holding the object.

### BACKGROUND ART

For example, in a production line with a plurality of machine tools arranged side by side, a conveying apparatus is installed to convey works between the machine tools. A conveying apparatus of this type is described in, for example, Patent Document 1. In the conveying apparatus, a conveying robot that holds works is provided so as to be movable along a rail beam. The conveying robot holding a work moves from externally above a machine tool into the inside of the machine tool to load the work from the outside to the inside of the machine tool. Furthermore, when the work is unloaded from the inside to the outside of the machine tool, the conveying robot moves from externally above the machine tool into the inside of the machine tool and then holds the work and moves externally upward.

Conveying robots different from the one described above are described in for example, Patent Documents 2 to 4. A conveying robot described in Patent Document 2 includes a bar-like member extending perpendicularly to the rail beam. The bar-like member moves upward and downward with respect to the rail beam, so that a head portion holding the work moves upward and downward.

A conveying robot described in Patent Document 3 has two parallel links. Patent Document 3 discloses that an upper end side of each of the parallel links is movably provided on the rail beam and that a lower end side of each parallel link is coupled to the head portion holding the work and that a separation distance between upper end sides of the two parallel links is changed to increase or reduce the height of the head portion. Furthermore, a conveying robot described in Patent Document 4 includes a single-arm link mechanism. A base side of the arm is supported by the rail beam. The work is held by a distal end side of the arm.

Patent Document 5 describes a four-degree-of-freedom parallel robot as an apparatus that is not a conveying robot conveying the work between machine tools as described above but that changes the position and orientation of the work.

### RELATED ART DOCUMENTS

### Patent Documents

Patent Document 1: Japanese Patent Application Publication No. H8-66878

Patent Document 2: Japanese Patent Application Publication No. 2010-149269

Patent Document 3: Japanese Patent Application Publication No. 2011-125950

Patent Document 4: Japanese Patent No. 5160700

Patent Document 5: Japanese Patent No. 4289506

### SUMMARY OF THE INVENTION

### Problem to be Solved by the Invention

However, the conveying robots described in Patent Documents 1, 2 extend far upward with an object moved upward. When the maximum height of the conveying robot exceeds a height limit in a factory in which the conveying robot is installed, this apparatus cannot be installed in the factory. Thus, the maximum height of the conveying robot is desired to be reduced.

Furthermore, in the conveying robot described in Patent Document 3, the two parallel links are separated from each other with the object lifted up. Consequently, the machine tool or the like that conveys the object needs to have a sufficient upper opening width. An increased upper opening width of the machine tool or the like inevitably involves increase in the width dimension of the machine tool or the like. Thus, the conveying robot restricts a reduction in the width of the machine tool.

Furthermore, the conveying robot described in Patent Document 4 is a single-arm link mechanism and thus fails to convey the object fast and stably.

The present invention has been developed in view of these circumstances. An object of the present invention is to provide a conveying robot that can have a reduced maximum height, conveys an object fast and stably, and that allows a reduction in an opening width of a destination to which the conveying robot conveys the object.

### Means for Solving the Problem

According to an aspect of the present invention, a conveying robot includes:

a base portion, a head portion enabled to hold an object,
a first driving link supported so as to be rotatable about a first base-side rotation support on the base portion,
a first driven link supported so as to be rotatable about a first intermediate rotation support on the first driving link and supported so as to be rotatable about a first tip-side rotation support on the head portion,
a second driving link supported so as to be rotatable about a second base-side rotation support on the base portion,
a second driven link supported so as to be rotatable about a second intermediate rotation support on the second driving link and supported so as to be rotatable about a second tip-side rotation support on the head portion, and
a driving apparatus provided on the base portion to rotationally drive the first driving link and the second driving link with respect to the base portion to change a position of the head portion with respect to the base portion.

The conveying robot in the above-described aspect further has at least one of a characteristic that the first driven link is formed to have a bent shape that protrudes toward the second driven link with respect to a straight line that connects the first intermediate rotation support and the first tip-side rotation support, and

a characteristic that the second driven link is formed to have a bent shape that protrudes toward the first driven link with respect to a straight line that connects the second intermediate rotation support and the second tip-side rotation support.

The conveying robot in the above-described aspect includes two parallel link systems, namely the first driving link and the first driven link, and the second driving link and the second driven link. Therefore, the conveying robot can convey the object stably and fast as compared to a conveying robot with a single-arm link mechanism.

Furthermore, in the conveying robot, the base portion and the head portion are coupled together by a parallel link mechanism. Thus, with the head portion placed close to the base portion, the link mechanism projects only a short distance. For example, when disposed above a machine tool or the like, the conveying robot can have a reduced maximum height.

Furthermore, the conveying robot has at least one of a characteristic that the first driven link is formed to have a bent shape that protrudes toward the second driven link with respect to a straight line that connects the first intermediate rotation support and the first tip-side rotation support, and a characteristic that the second driven link is formed to have a bent shape that protrudes toward the first driven link with respect to a straight line that connects the second intermediate rotation support and the second tip-side rotation support. As compared to a case where the first driven link and the second driven link are assumed to be linear members, the present configuration reduces a separation distance between a part of the first driven link that is close to the head portion and a corresponding part of the second driven link that is close to the head portion. Therefore, the opening width of a destination to which the conveying robot conveys the object can be reduced.

According to another aspect of the present invention, the conveying robot may include:

an intermediate coupling portion supported so as to be rotatable about the first intermediate rotation support with respect to the first driving link and supported so as to be rotatable about the first intermediate rotation support with respect to the first driven link,
a base-side parallel link supported so as to be rotatable about a third base-side rotation support on the base portion and supported so as to be rotatable about a third intermediate rotation support on the intermediate coupling portion, the base-side parallel link being provided in parallel with the first driving link, and
a tip-side parallel link supported so as to be rotatable about a fourth intermediate rotation support on the intermediate coupling portion and supported so as to be rotatable about a third tip-side rotation support on the head portion, the tip-side parallel link being provided in parallel with the first driven link.

In other words, the first base-side rotation support, the first intermediate rotation support, the third base-side rotation support, and the third intermediate rotation support form vertices of a parallelogram. This keeps an orientation of the intermediate coupling portion with respect to the base portion constant. Moreover, the first intermediate rotation support, the first tip-side rotation support, the fourth intermediate rotation support, and the third tip-side rotation support form vertices of a parallelogram. This keeps an orientation of the head portion with respect to the intermediate coupling portion constant. In other words, an orientation of the head portion with respect to the base portion is kept constant. Therefore, the object can be conveyed with an orientation thereof kept stable.

According to yet another aspect of the present invention, in the conveying robot in the above-described aspect,

the tip-side parallel link may be formed to have a bent shape that protrudes toward the second driven link with respect to a straight line that connects the fourth intermediate rotation support and the third tip-side rotation support. If the conveying robot has the base-side parallel link and the tip-side parallel link, configuring the tip-side parallel link as described above allows reducing a separation distance between a part of the tip-side parallel link that is close to the head portion and a corresponding part of the second driven link that is close to the head portion, in addition to the head-portion-side separation distance between the first driven link and the second driven link. Therefore, the opening width of the destination to which the conveying robot conveys the object can be reduced.

According to still another aspect of the present invention, in the conveying robot in the above-described aspect,

the driving apparatus may include one rotational driving source, and
a transmission apparatus that transmits a rotational driving force of the rotational driving source to each of the first driving link and the second driving link. This allows easy synchronization of rotational phases of the first driving link and the second driving link.

According to further another aspect of the present invention, in the conveying robot in the above-described aspect,

the transmission apparatus may include one worm coupled to an output shaft of the rotational driving source or formed integrally with output shaft,
a first worm wheel attached to the first driving link at the first base-side rotation support to mesh with the worm, and
a second worm wheel attached to the second driving link at the second base-side rotation support to mesh with the worm. This allows easy synchronization of rotational phases of the first driving link and the second driving link, while achieving a high speed reduction ratio.

According to further another aspect of the present invention, in the conveying robot in the above-described aspect,

a lead angle of the worm may be set to such a lead angle that allows the worm to rotate when, in conjunction with rotation of at least one of the first worm wheel and the second worm wheel, motive power is transmitted from the worm wheel to the worm. In other words, self-lock is prevented from acting on the transmission apparatus. As a result, for example, if the link or the like is subjected to an external impact force, the worm rotates to reduce a load on meshed teeth of the worm wheel and the worm. Therefore, the life of the meshed teeth is prolonged.

### BRIEF DESCRIPTION OF THE DRAWINGS

FIG. 1 is a perspective view of a conveying apparatus in the present embodiment.

FIG. 2 is an enlarged sectional view of a coupling portion of a first pillar and a rail beam both included in the conveying apparatus in FIG. 1 as seen in a direction orthogonal to a conveying direction.

FIG. 3 is an enlarged sectional view of a coupling portion of a plurality of rail beams included in the conveying apparatus as seen in the direction orthogonal to the conveying direction.

FIG. 4 is a perspective view of a conveying robot included in the conveying apparatus in FIG. 1.

FIG. 5 is a front view of the conveying robot in FIG. 4.

FIG. 6 is a right side view of the conveying robot in FIG. 4.

FIG. 7 is a rear view of the conveying robot in FIG. 4.

FIG. 8 is a configuration diagram of a speed reducer included in the conveying robot in FIG. 4.

FIG. 9 is a schematic diagram of the conveying robot which illustrates the magnitudes of transmitted forces when a driving force exerted by an up-down driving motor is transmitted from a worm to a first worm wheel and a second worm wheel.

FIG. 10 is a schematic diagram of the conveying robot illustrating the magnitudes of forces transmitted from the first worm wheel to the worm when a first driving link is externally subjected to an upward impact force.

### MODES FOR CARRYING OUT THE INVENTION

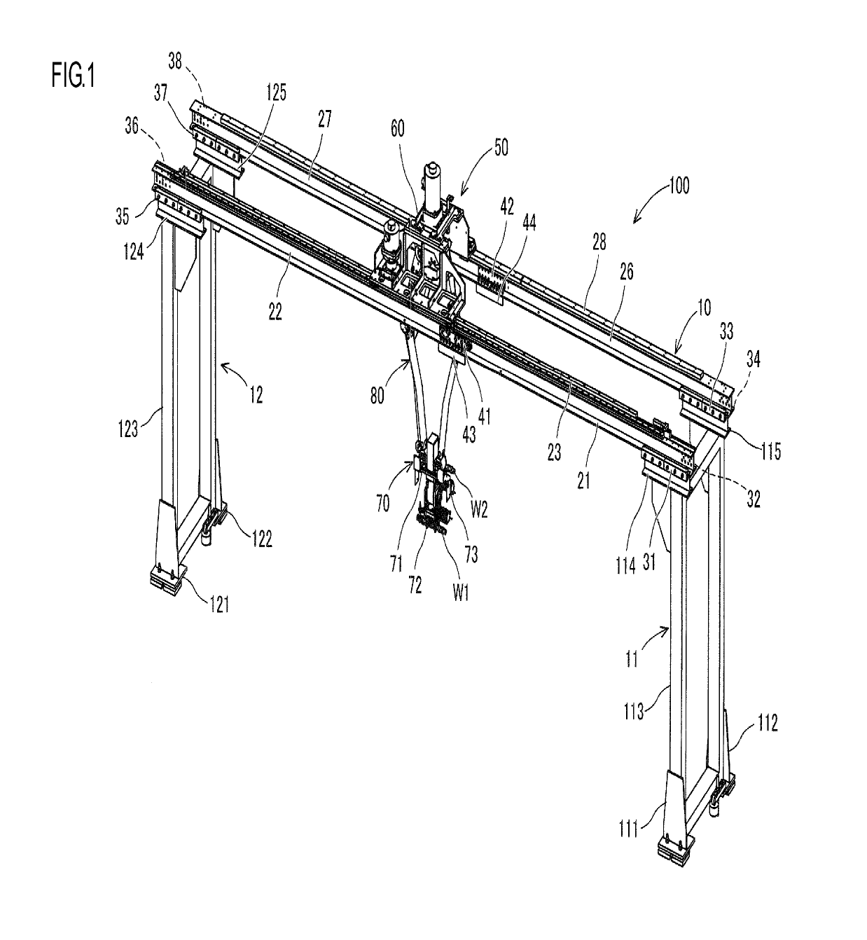

A conveying apparatus 100 will be described with reference to FIG. 1. The conveying apparatus 100 is applied to a production line with a plurality of machine tools (not depicted in the drawings) or the like arranged side by side to convey, between the machine tools or the like, works that are objects to be conveyed.

As depicted in FIG. 1, the conveying apparatus 100 includes a base stand portion 10 fixed at an installation site and a conveying robot 50 (corresponding to a moving body) supported by the base stand portion 10 so as to be movable in a conveying direction while holding objects W1, W2.

The base stand portion 10 includes a plurality of pillars 11, 12, a plurality of rail beams 21, 22 in a first row, a guide rail 23 in the first row, a plurality of rail beams 26, 27 in a second row, a guide rail 28 in the second row, a plurality of coupling members 31 to 38 for pillars and beams, and a plurality of coupling members 41 to 44 used between beams.

The pillars 11, 12 includes seat portions 111, 112, 121, 122, main body portions 113, 123, and upper end members 114, 115, 124, 125. The seat portions 111, 112, 121, 122 are positioned at the installation site.

The first and second main body portions 113, 123 are shaped like rectangular frames using hollow square bars. Although the first and second main body portions 113, 123 are shaped like frames, a pillar portion of each of the main body portions may be an independent bar member.

The first main body portion 113 and the second main body portion 123 are spaced from each other in the conveying direction. Moreover, the first main body portion 113 and the second main body portion 123 are disposed such that the rectangular frames face each other in the conveying direction. A plurality of machine tools is installed between the first main body portion 113 and the second main body portion 123. The first main body portion 113 is fixed on the seat portions 111, 112, for example, by welding. The second main body portion 123 is fixed on the seat portions 121, 122, for example, by welding.

The upper end members 114, 115, 124, 125 are formed using, for example, I sections. The upper end member 114 is fixed to one corner of an upper end of the first main body portion 113, for example, by welding. The upper end member 115 is fixed to another corner of the upper end of the first main body portion 113, for example, by welding. Furthermore, the upper end member 124 is fixed to one corner of an upper end of the second main body portion 123, for example, by welding. The upper end member 125 is fixed to another corner of the upper end of the second main body portion 123, for example, by welding.

The rail beam 21 and the other rail beam 22 in the first row are formed using, for example, I sections and configured to extend in a longitudinal direction that is the conveying direction. In other words, the rail beams 21, 22 in the first row are positioned such that respective ends of the rail beams 21, 22 are in abutting contact with each other.

One end side of the rail beam 21 in the first row is disposed on an upper surface of the upper end member 114 of the first pillar 11. One end side of the other rail beam 22 in the first row is disposed on an upper surface of the upper end member 124 of the second pillar 12. In this manner, the rail beams 21, 22 in the first row bridge the first pillar 11 and the second pillar 12. The guide rail 23 in the first row is provided on upper surfaces of the rail beams 21, 22 in the first row. As the guide rail 23 in the first row, for example, a linear rolling bearing is applied.

In this case, a position where the other end side of the rail beam 21 and the other end side of the other rail beam 22 in the first row are in abutting contact with each other is displaced from the pillars 11, 12. In other words, the abutting contact position is not supported by the pillars 11, 12. These portions are coupled together by the coupling members 41, 42 described below.

The rail beam 26 and the other rail beam 27 in the second row are formed using, for example, I sections and configured to extend in the longitudinal direction that is the conveying direction. In other words, the rail beams 26, 27 in the second row are positioned such that respective ends of the rail beams 26, 27 are in abutting contact with each other.

Moreover, the rail beams 26, 27 in the second row are disposed parallel to the rail beams 21, 22 in the first row. Furthermore, one end side of the rail beam 26 in the second row is disposed on an upper surface of the upper end member 115 of the first pillar 11. One end side of the other rail beam 27 in the second row is disposed on an upper surface of the upper end member 125 of the second pillar 12. In this manner, the rail beams 26, 27 in the second row bridge the first pillar 11 and the second pillar 12. The guide rail 28 in the second row is provided on upper surfaces of the rail beams 26, 27 in the second row. As the guide rail 28 in the second row, for example, a linear rolling bearing is applied.

In this case, a position where the other end side of the rail beam 26 and the other end side of the other rail beam 27 in the second row are in abutting contact with each other is displaced from the pillars 11, 12. In other words, the abutting contact position is not supported by the pillars 11, 12. These portions are coupled together by the coupling members 43, 44 described below.

The coupling members 31 to 38 for pillars and beams (corresponding to first and second coupling members) are U-shaped. The coupling members 31 to 38 for pillars and beams are formed of, for example, U sections. The coupling members 31, 32 for pillars and beams couple the upper end member 114 of the first pillar 11 to the rail beam 21 in the first row. The coupling members 33, 34 for pillars and beams couple the upper end member 115 of the first pillar 11 to the rail beam 26 in the second row. The coupling members 35, 36 for pillars and beams couple the upper end member 124 of the second pillar 12 to the rail beam 22 in the first row. The coupling members 37, 38 for pillars and beams couple the upper end member 125 of the second pillar 12 to the rail beam 27 in the second row. In this case, in FIG. 1, the coupling members 31, 33, 35, 37 for pillars and beams are positioned so as to facing the viewer, whereas the coupling members 32, 34, 36, 38 for pillars and beams are positioned so as to away from the viewer.

The coupling members 41, 42 used between beams (corresponding to third coupling members) continuously connect the rail beams 21, 22 in the first row together in the conveying direction. Specifically, the coupling member 41 used between beams couples a lower surface of the rail beam 21 to a lower surface of the other rail beam 22 in the first row. The coupling member 42 used between beams couples a side surface of the rail beam 21 to a side surface of the other rail beam 22 in the first row.

The coupling members 43, 44 used between beams (corresponding to third coupling members) continuously connect the rail beams 26, 27 in the conveying direction. Specifically, the coupling member 43 used between beams couples a lower surface of the rail beam 26 to a lower surface of the other rail beam 27 in the second row. The coupling member 44 used between beams couples a side surface of the rail beam 26 to a side surface of the other rail beam 27 in the second row.

The conveying robot 50 is supported at a front and a rear sides thereof by the rail beams 21, 22 in the first row and the rail beams 26, 27 in the second row. In other words, the conveying robot 50 is supported at both ends thereof. The conveying robot 50 includes a base portion 60 fixed to the rail beams 21, 22, 26, 27 in an up-down direction, a head portion that is movable in the up-down direction with respect to the base portion 60 and that can hold objects W1, W2, and a link mechanism 80 for moving the head portion 70 in the up-down direction with respect to the base portion 60. The base portion 60 and the link mechanism 80 will be described below in detail.

As depicted in FIG. 1, the head portion 70 includes a head main body 71, a first hand portion 72, and a second hand portion 73. The first and second hand portions 72, 73 can hold the objects W1, W2, respectively, and can also release the objects W1, W2, respectively. Moreover, the first and second hand portions 72, 73 are shaped to conform to the shapes of the objects W1, W2. The first and second hand portions 72, 73 are interchangeable in position with respect to the head main body 71. When the first hand portion 72 holds the object W1, which is an unmachined work, the second hand portion 73 receives the object W2, which is a machined work, from a machine tool. The first hand portion 72 then can deliver the object W1, which is an unmachined work, to the machine tool. As the first and second hand portions 72, 73, various known hand portions are applicable.

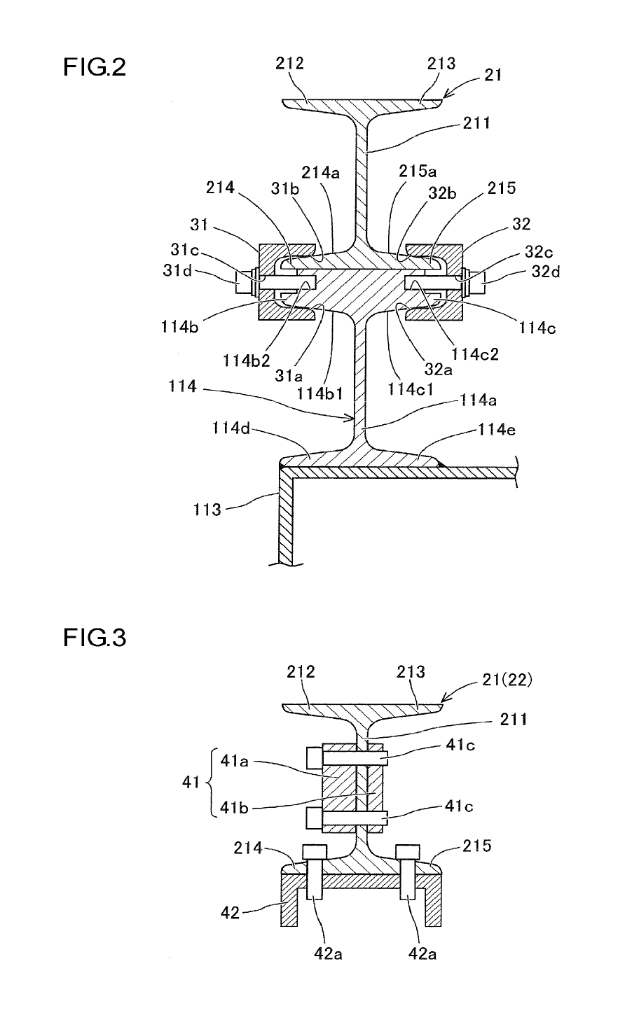

Now, a portion in which the first pillar 11 and the rail beam 21 are coupled together will be described with reference to FIG. 2. The upper end member 114 of the first pillar 11 is formed of, for example, an I section. In other words, the upper end member 114 includes a main body portion 114a (corresponding to a pillar main body portion), a pair of upper flanges 114b, 114c (corresponding to pillar flanges) formed so as to project from an upper edge of the main body portion 114a in laterally opposite directions, and a pair of lower flanges 114d, 114e formed so as to project from a lower edge of the main body portion 114a in laterally opposite directions.

The main body portion 114a is formed like a flat plate extending in the conveying direction. Upper surfaces of the upper flanges 114b, 114c are formed to lie on the same horizontal plane. On lower surfaces of the upper flanges 114b, 114c, inclined surfaces 114b1, 114c1 are formed which incline laterally upward from the main body portion 114a side. Moreover, in a right surface of the upper flange 114c and a left surface of the upper flange 114b in FIG. 2, internal threads 114c2, 114b2, respectively, are formed.

Lower surfaces of the lower flanges 114d, 114e are formed to lie on the same horizontal plane and fixed to a corner of the upper end of the first main body portion 113, for example, by welding. On upper surfaces of the lower flanges 114d, 114e, inclined surfaces are formed which incline laterally downward from the main body portion 114a side. In other words, the thickness of each of the lower flanges 114d, 114e gradually decreases from the main body portion 114a side in a lateral direction.

The rail beam 21 is formed of, for example, an I section. In other words, the rail beam 21 includes a beam main body portion 211 extending in the longitudinal direction, a pair of upper flanges 212, 213 formed so as to project from an upper edge of the beam main body portion 211 in laterally opposite directions, and a pair of lower flanges 214, 215 (corresponding to beam flanges) formed so as to project from a lower edge of the beam main body portion 211 in laterally opposite directions.

The beam main body portion 211 is formed generally like a flat plate. Upper surfaces of the upper flanges 212, 213 are formed to lie on the same horizontal plane. On lower surfaces of the upper flanges 212, 213, inclined surfaces are formed which incline laterally upward from the beam main body portion 211 side. In other words, the thickness of each of the upper flanges 212, 213 gradually decreases from the beam main body portion 211 side in the lateral direction.

Upper surfaces of the lower flanges 214, 215 are formed to lie on the same horizontal plane. On upper surfaces of the lower flanges 214, 215, inclined surfaces 214a, 215a are formed which incline laterally downward from the beam main body portion 211 side. In other words, the thickness of each of the lower flanges 214, 215 gradually decreases from the beam main body portion 211 side in the lateral direction.

The coupling member 31 between a pillar and a beam (corresponding to a first coupling member) is U-shaped. Edges 31a, 31b inside the U shape of the coupling member 31 are shaped like curved protrusions. Moreover, in the coupling member 31, a through-hole 31c is formed which penetrates the coupling member 31 in a direction in which the U shape is open. The coupling member 31 holds the upper flange 114b of the upper end member 114 and the lower flange 214 of the rail beam 21 in a sandwiching manner in the up-down direction. In other words, the edge 31a of the coupling member 31 contacts the inclined surface 114b1 of the upper flange 114b, and the other edge 31b of the coupling member 31 contacts the inclined surface 214a of the lower flange 214.

A fastening bolt 31d is inserted through the through-hole 31c and screw-threaded into the internal thread 114b2 of the upper flange 114b of the upper end member 114. In other words, the fastening bolt 31d is attached to the upper end member 114 so as to be immovable in the up-down direction.

Moreover, the fastening bolt 31d is fastened into the internal thread 114b2 to bring the coupling member 31 closer to the main body portion 114a of the upper end member 114 and the beam main body portion 211 of the rail beam 21. Due to a wedge effect, the edges 31a, 31b on opposite inner surfaces of the coupling member 31 are pressed against the inclined surfaces 114b1, 214a, respectively, in the up-down direction. As a result, the upper flange 114b of the upper end member 114 and the lower flange 214 of the rail beam 21 are coupled together.

Furthermore, the coupling member 32 between a pillar and a beam (corresponding to a second coupling member) is provided on the opposite side of the upper end member 114 and the rail beam 21 from the above-described coupling member 31. A fixing method for the coupling member 32 is similar to the fixing method for the coupling member 31. In other words, the coupling member 32 is U-shaped, and edges 32a, 32b inside the U shape of the coupling member 32 are shaped like curved protrusions. Moreover, in the coupling member 32, a through-hole 32c is formed which penetrates the coupling member 32 in a direction in which the U shape is open. The coupling member 32 holds the other upper flange 114c of the upper end member 114 and the other lower flange 215 of the rail beam 21 in a sandwiching manner in the up-down direction. In other words, the edge 32a of the coupling member 32 contacts the inclined surface 114c1 of the upper flange 114c, and the other edge 32b of the coupling member 32 contacts the inclined surface 215a of the lower flange 215.

A fastening bolt 32d is inserted through the through-hole 32c and screw-threaded into the internal thread 114c2 of the upper flange 114c. In other words, the fastening bolt 32d is attached to the upper end member 114 so as to be immovable in the up-down direction.

Moreover, the fastening bolt 32d is fastened into the internal thread 114c2 to bring the coupling member 32 closer to the main body portion 114a of the upper end member 114 and the beam main body portion 211 of the rail beam 21. Due to the wedge effect, the edges 32a, 32b on opposite inner surfaces of the coupling member 32 are pressed against the inclined surfaces 114c1, 215a, respectively, in the up-down direction. As a result, the other upper flange 114c of the upper end member 114 and the other lower flange 215 of the rail beam 21 are coupled together.

Now, a portion in which the rail beams 21, 22 are coupled together will be described with reference to FIG. 3. The coupling member 41 between rail beams (corresponding to a third coupling member) couples the main body portions 211 of the rail beams 21, 22 together. Specifically, the coupling member 41 includes two members 41a, 41b so as to sandwich the main body portions 211 of the rail beams between the two members 41a, 41b. The two members 41a, 41b couple the main body portions 211 of the rail beams 21, 22 together via bolts 41c.

Furthermore, the coupling member 42 between rail beams (corresponding to a third coupling member) couples the lower flanges 214, 215 of the rail beams 21, 22 together. The coupling member 42 is U-shaped. The coupling member 42 is attached to the lower flanges 214, 215 of the rail beams 21, 22 via bolts 42a.

As described above, the lower flange 214 of the rail beam 21 is provided all along the length of a lower edge of the rail beam main body portion 211. Therefore, the coupling member 31 for a pillar and a beam can be attached to the rail beam 21 at any position thereof. In other words, the coupling member 31 allows the upper flange 114b of the upper end member 114 of the first pillar 11 to be coupled to the rail beam 21 at any position thereof. The position of the first pillar 11 can be moved without the need to move the rail beam 21.

Therefore, for example, when the layout of machine tools is changed, only the position of the first pillar 11 needs to be changed, and the position of the rail beam 21 need not be changed. As a result, it is possible to easily deal with a change in layout.

Furthermore, when the lower surface of the upper flange 114b of the upper end member 114 is formed as the inclined surface 114b1 and the upper surface of the lower flange 214 of the rail beam 21 is formed as the inclined surface 214a, the upper flange 114b and the lower flange 214 function for the coupling member 31 as wedge shapes. Therefore, both flanges 114b, 214 are reliably coupled together by the coupling member 31. In other words, the above-described configuration allows the first pillar 11 to be very freely disposed and enables reliable couplings.

Furthermore, the edges 31a, 31b of the opposite inner surfaces of the coupling member 31 are shaped like curved protrusions. The edges 31a, 31b slide on the inclined surfaces 114b1, 214a when both flanges 114b, 214 are coupled together by the coupling member 31. The edges 31a, 31b are shaped like curved protrusions and thus enable the coupling member 31 to slide easily, allowing both flanges 114b, 214 to be coupled together in a desired state.

Moreover, the coupling members 31 and 32 are provided on the opposite to sides of the upper end member 114 and the rail beam 21 from each other. In other words, the coupling member 31 couples the flanges 114b, 214 together, and the coupling member 32 on the opposite side couples both flanges 114c, 215 together. Consequently, the upper end member 114 of the first pillar 11 and the rail beam 21 are reliably coupled together.

As described above, the conveying robot 50 is supported at both ends thereof by the rail beams 21, 22 in the first row and the rail beams 26, 27 in the second row. Consequently, the conveying robot 50 can move stably. When the rail beams 21, 22 in the first row are disposed parallel to the rail beams 26, 27 in the second row, the pillars 11, 12 need to be configured so as to allow each of the rail beams 21, 22, 26, 27 to be supported.

In the present embodiment, the pillars 11, 12 are shaped like rectangular frames, and unlike simple bar-like pillars, provide a single structure that can support the rail beams in two rows. Adoption of the bar-like pillars increases the number of pillars as compared to adoption of the pillars in the present embodiment. Thus, when the rail beams 21, 22, 26, 27 are disposed parallel to one another, the pillars 11, 12 are less freely disposed. The pillars 11, 12 and the rail beams 21, 22, 26, 27 can be easily installed by adopting the rectangular-frame-shaped pillars 11, 12 and applying the structure in which the pillars and the rail beams 21, 22, 26, 27 are coupled together as described above, instead of using bar-like pillars.

In the present embodiment, the position of the coupling portion of the rail beams 21, 22 in the first row is displaced from the pillars 11, 12. The rail beams 21, 22 are coupled together by the coupling members 41, 42. Smaller lengths of the rail beams 21, 22 allow manufacture and conveyance to be more easily achieved, and thus, the lengths of the rail beams 21, 22 are limited. When a large distance is present between the pillars 11, 12, the rail beams 21, 22 can be installed between the pillars 11, 12 by coupling the rail beams 21, 22 with the ends thereof in abutting contact with each other.

When the rail beams 21, 22 are coupled together for use, the conveying robot 50 is supported at both ends thereof by the rail beams 21, 22 in the first row and the rail beams 26, 27 in the second row. This can suppress the rail beams 21, 22 from being twisted due to the weight of the conveying robot 50. As described above, since an area where the rail beams 21, 22 coupled together in the longitudinal direction are coupled to each other can be disposed regardless of the positions of the pillars 11, 12, the pillars 11, 12 and the rail beams 21, 22 are more freely disposed.

Now, a configuration of the conveying robot 50 will be described with reference to FIG. 1 and FIGS. 4 to 8. The conveying robot 50 includes the base portion 60, the head portion 70, the link mechanism 80, and a driving apparatus 90.

As depicted in FIG. 1, the base portion 60 is supported at both ends thereof by the rail beams 21, 22 in the first row and the rail beams 26, 27 in the second row. The base portion 60 slides along the guide rails 23, 28 to move in a longitudinal direction of the guide rails. The base portion 60 includes a base main body 61, a speed reducer case 62, a front bracket 63, and a rear bracket 64.

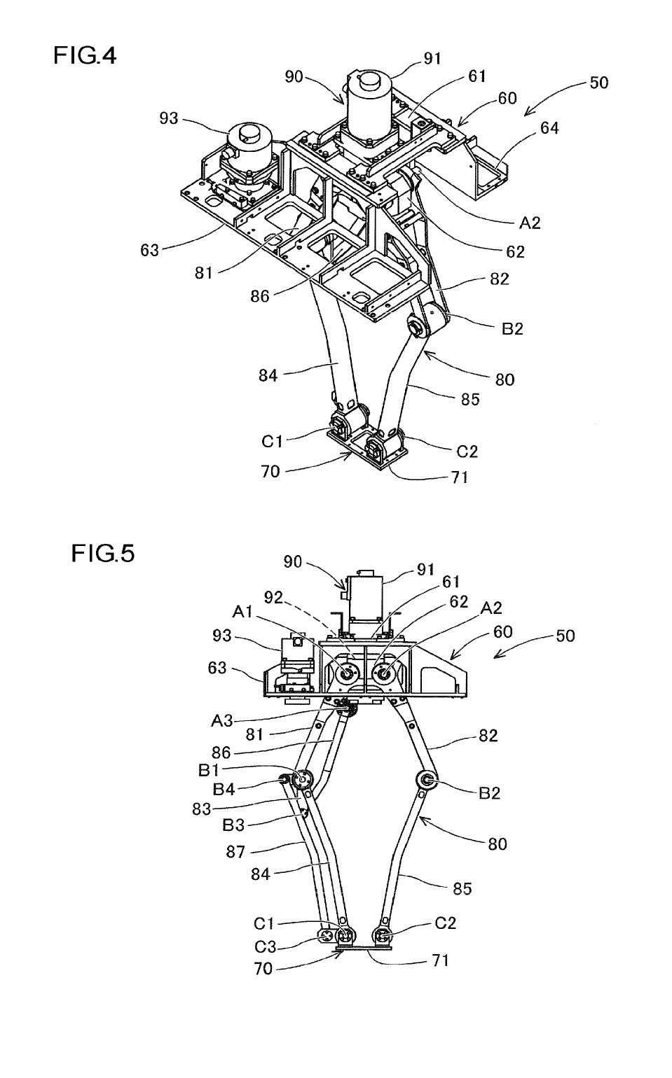

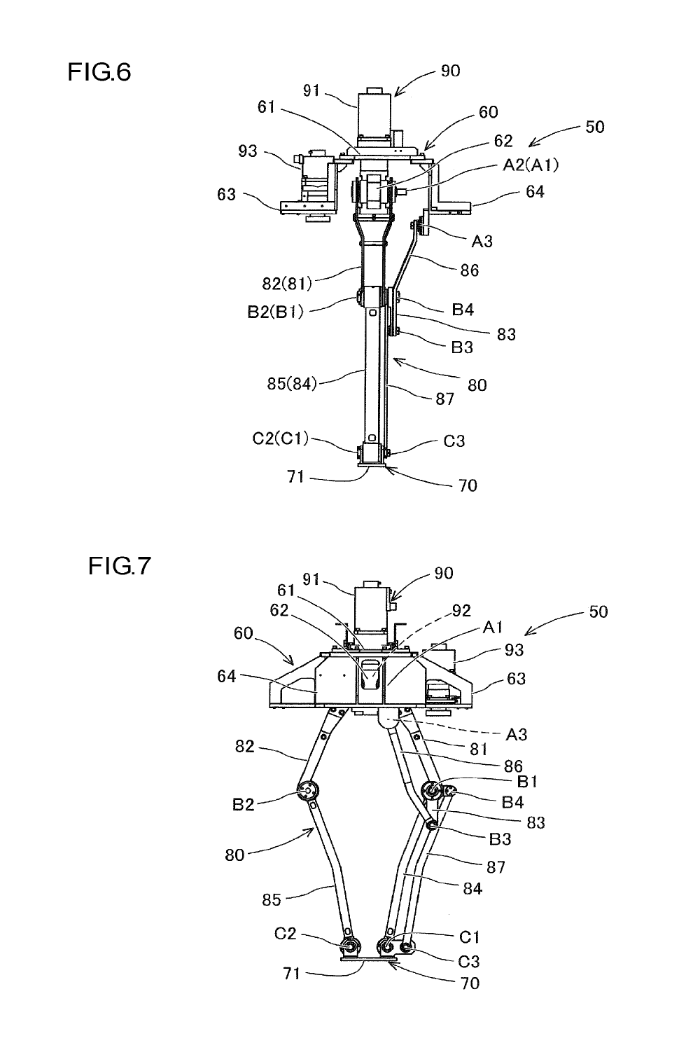

The base main body 61 is a portion formed generally like a flat plate as depicted in FIG. 4, FIG. 6. As depicted in FIG. 1, the base main body 61 is positioned above the rail beams 21, 22, 26, 27 and between the rail beams 21, 22 in the first row and the rail beams 26, 27 in the second row.

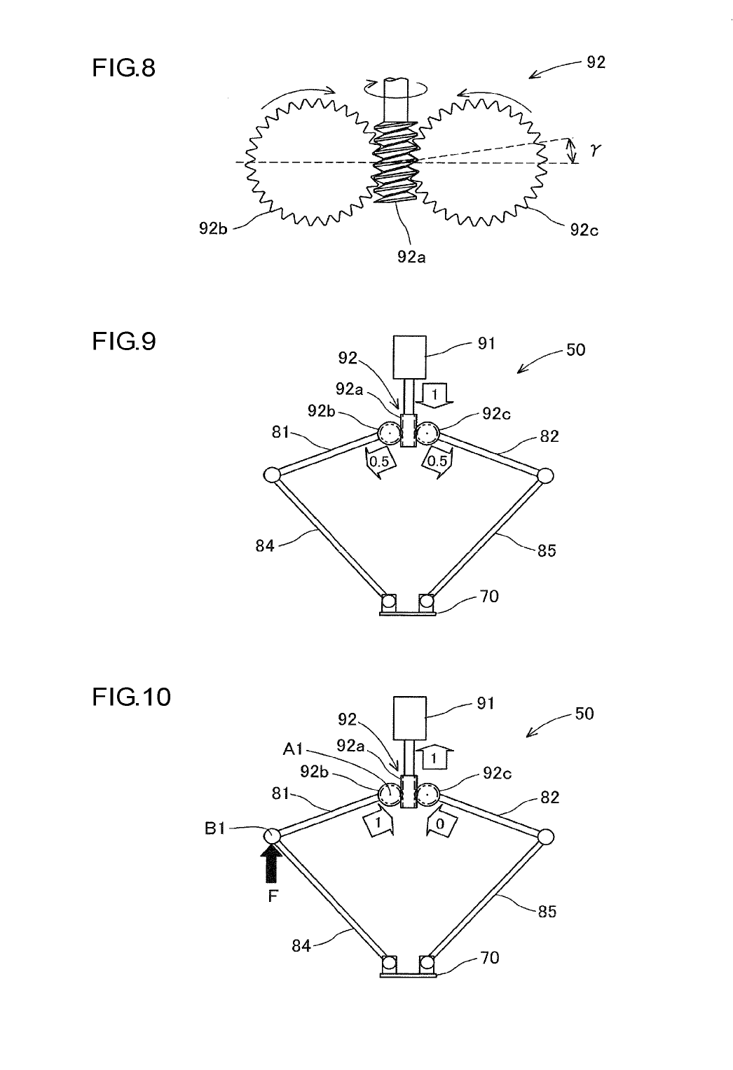

The speed reducer case 62 is fixed to a lower surface of the base main body 61 and internally houses a speed reducer 92 (depicted in FIG. 8) included in the driving apparatus 90. The speed reducer case 62 includes a support shaft centered about a first base-side rotation support A1 and a support shaft centered about a second base-side rotation support A2. When the conveying robot is likened to the human arms, these base-side rotation supports correspond to the shoulder joints. In this case, the first base-side rotation support A1 and the second base-side rotation support A2 are provided at the same height. Rotation axes at both rotation supports A1, A2 are parallel to each other.

As depicted in FIG. 6, the front bracket 63 is L-shaped and provided integrally with a front side, in FIG. 1, (the side of the rail beams 21, 22 in the first row) of the base main body 61. As depicted in FIG. 1, a lower surface of the front bracket 63 is slidably supported on the guide rail 23 in the first row.

As depicted in FIG. 6, the rear bracket 64 is L-shaped and provided integrally with a rear side, in FIG. 1, (the side of the rail beams 26, 27 in the second row) of the base main body 61. As depicted in FIG. 1, a lower surface of the rear bracket 64 is slidably supported on the guide rail 28 in the second row. Moreover, the rear bracket 64 includes a support shaft with a third base-side rotation support A3. The third base-side rotation support A3 is provided at a position different from positions where the first and second base-side rotation supports A1, A2 are provided.

As depicted in FIG. 1, the head portion 70 includes the head main body 71, the first hand portion 72, and the second hand portion 73. However, FIGS. 4 to 7 depict only the head main body 71. The head main body 71 includes a support shaft centered about a first tip-side rotation support C1, a support shaft centered about a second tip-side rotation support C2, and a support shaft centered about a third tip-side rotation support C3. When the conveying robot is likened to the human arms, these tip-side rotation supports correspond to the wrist joints. In this case, the first tip-side rotation support C1 and the second tip-side rotation support C2 are provided at the same height. Rotation axes at both rotation supports C1, C2 are parallel to each other. Furthermore, the third tip-side rotation support C3 is provided at a position different from positions where the first and second tip-side rotation supports C1, C2 are provided.

The link mechanism 80 moves the head portion 70 in the up-down direction with respect to the base portion 60 as depicted in FIG. 4, FIG. 5. The link mechanism 80 has a double-arm pantograph structure. The link mechanism 80 includes a first driving link 81, a second driving link 82, an intermediate coupling portion 83, a first driven link 84, a second driven link 85, a base-side parallel link 86, and a tip-side parallel link 87.

The first driving link 81 is a linear link member. The first driving link 81 is supported so as to be rotatable about the first base-side rotation support A1 on the base portion 60. The second driving link 82 is a linear link member. The second driving link 82 is supported so as to be rotatable about the second base-side rotation support A2 on the base portion 60.

The intermediate coupling portion 83 is L-shaped. The intermediate coupling portion 83 includes a support shaft centered about a first intermediate rotation support B1, a support shaft centered about a third intermediate rotation support B3, and a support shaft centered about a fourth intermediate rotation support B4. When the conveying robot is likened to the human arms, these intermediate rotation supports correspond to the elbow joints. In this case, the first intermediate rotation support B1, the third intermediate rotation support B3, the first base-side rotation support A1, and the third base-side rotation support A3 form respective vertices of a parallelogram. The intermediate coupling portion 83 is rotatably supported at the first intermediate rotation support B1 on the first driving link 81.

The first driven link 84 is rotatably supported at the first intermediate rotation support B1 on the first driving link 81 and the intermediate coupling portion 83. The first driven link 84 is further rotatably supported at the first tip-side rotation support C1 on the head main body 71 of the head portion 70.

As depicted in FIG. 5 and FIG. 7, the first driven link 84 is formed to have a bent shape that protrudes toward the second driven link 85 (the right side of FIG. 5) with respect to a straight line that connects the first intermediate rotation support B1 and the first tip-side rotation support C1. In the present embodiment, the first driven link 84 is shaped such that two linear members cross each other at a predetermined angle. Alternatively, the first driven link 84 may be shaped like a circular arc that is curved all along the length of the first driven link 84.

The second driven link 85 is supported so as to be rotatable about the second intermediate rotation support B2 on the second driving link 82. The second driven link 85 is further supported so as to be rotatable about the second tip-side rotation support C2 on the head main body 71 of the head portion 70. The second driven link 85 is formed to have a bent shape that protrudes toward the first driven link 84 (the left side of FIG. 5) with respect to a straight line that connects the second intermediate rotation support B2 and the second tip-side rotation support C2. Alternatively, the second driven link 85 may be shaped like a circular arc that is curved all along the length of the second driven link 85.

The base-side parallel link 86 is supported so as to be rotatable about the third base-side rotation support A3 on the base portion 60 and is also supported so as to be rotatable about the third intermediate rotation support B3 on the intermediate coupling portion 83. Moreover, the base-side parallel link 86 is provided parallel to the first driving link 81.

The tip-side parallel link 87 is supported so as to be rotatable about the fourth intermediate rotation support B4 on the intermediate coupling portion 83 and is also supported so as to be rotatable about the third tip-side rotation support C3 on the head main body 71 of the head portion 70. Moreover, the tip-side parallel link 87 is provided parallel to the first driven link 84. The first intermediate rotation support B1, the fourth intermediate rotation support B4, the first tip-side rotation support C1, and the third tip-side rotation support C3 form respective vertices of a parallelogram.

The tip-side parallel link 87 is formed to have a bent shape that protrudes toward the second driven link 85 (the right side of FIG. 5) with respect to a straight line that connects the fourth intermediate rotation support B4 and the third tip-side rotation support C3. In the present embodiment, the tip-side parallel link 87 is shaped substantially similarly to the first driven link 84. Alternatively, the tip-side parallel link 87 may be shaped like a circular arc that is curved all over the length of the tip-side parallel link 87. Furthermore, the tip-side parallel link 87 may be shaped differently from the first driven link 84.

In addition, as depicted in FIG. 5 and FIG. 7, the first and second base-side rotation supports A1, A2, the first and second intermediate rotation supports B1, B2, and the first and second tip-side rotation supports C1, C2 form vertices of a hexagon. This hexagon is shaped such that the interior angles of at least the first and second intermediate rotation supports B1, B2 are each less than 180°.

The driving apparatus 90 includes an up-down driving motor 91, the speed reducer 92, and a slide motor 93. The up-down driving motor 91 (corresponding to a rotational driving source in the claims) is fixed to an upper surface of the base main body 61. An output shaft of the up-down driving motor 91 rotates about the up-down direction.

The speed reducer 92 amplifies a rotational driving force of the up-down driving motor 91 to transmit the amplified rotational driving force to each of the first driving link 81 and the second driving link 82. As depicted in FIG. 8, the speed reducer 92 includes one worm 92a, a first worm wheel 92b, and a second worm wheel 92c. The worm 92a is coupled to the output shaft of the up-down driving motor 91 or formed integrally with the output shaft. The first worm wheel 92b is attached to the first driving link 81 at the first base-side rotation support A1 to mesh with the worm 92a. The second worm wheel 92c is attached to the second driving link 82 at the second base-side rotation support A2 to mesh with the worm 92a.

A lead angle γ of the worm 92a is set to an angle at which a self-lock action does not occur in the speed reducer 92. Thus, the worm 92a rotates when, in conjunction with rotation of at least one of the first worm wheel 92b and the second worm wheel 92c, motive power is transmitted from the first worm wheel 92b or the second worm wheel 92c to the worm 92a. For example, the lead angle γ of the worm 92a is set to 5° or more.

As depicted in FIG. 4, the slide motor 93 is fixed to the front bracket 63 of the base portion 60. Driving of the slide motor 93 causes the whole conveying robot 50 to move slidably along the rail beams 21, 22 in the first row.

Now, operations of the link mechanism 80 and the head portion 70 will be described with reference to FIG. 5 and FIG. 8. In a state depicted in FIG. 5, the up-down driving motor 91 is driven. The rotational driving force of the up-down driving motor 91 is then transmitted to the worm 92a, which rotates to transmit the rotational driving force to the first and second worm wheel 92b, 92c. The first worm wheel 92b rotates to allow the first driving link 81 to rotate about the first base-side rotation support A1. On the other hand, the second worm wheel 92c rotates to allow the second driving link 82 to rotate about the second base-side rotation support A2.

In this case, the first and second worm wheels 92b, 92c mesh with the single worm 92a. Thus, the first and second worm wheels 92b, 92c rotate in opposite directions, and rotational phases of the first and second worm wheels 92b, 92c are mechanically synchronized with each other. In other words, this configuration allows the rotational phases of the first and second worm wheel 92b, 92c to be easily synchronized with each other. Furthermore, a high speed reduction ratio can be achieved by application of the worm 92a and the first and second worm wheels 92b, 92c.

An assumption is made that, in the state in FIG. 5, the first driving link 81 rotates clockwise, whereas the second driving link 82 rotates counterclockwise. The separation distance between the first intermediate rotation support B1 and the second intermediate rotation support B2 is increased. Furthermore, in conjunction with the above-described rotation of the first and second driving links 81, 82, the first driven link 84 and the second driven link 85 move upward. Therefore, the head portion 70 moves upward. Downward movement of the head portion 70 can be achieved by rotationally driving the up-down driving motor 91 in a direction opposite to the above-described direction.

In this case, as compared to a single-arm link mechanism, the double-arm link mechanism 80 applied to the conveying robot 50 as described above allows the objects W1, W2 to be conveyed stably and fast in the up-down direction. In particular, when the head portion 70 is moved downward, the configuration in the present embodiment serves to reduce the rate of change in descending speed of the head portion 70 with respect to the rate of change in angular velocity of the up-down driving motor 91. Therefore, when the head portion 70 is set at a lower position, the setting operation can be stabilized.

Furthermore, in the conveying robot 50, the base portion 60 and the head portion 70 are coupled together by the link mechanism 80. Thus, with the head portion 70 located close to the base portion 60, the link mechanism 80 projects only a short distance and thus has only a small height in the up-down direction. Consequently, when the conveying robot 50 is disposed above the machine tool or the like, the maximum height of the conveying robot 50 can be reduced.

In this case, since the first and third base-side rotation supports A1, A3 and the first and third intermediate rotation supports B1, B3 form the respective vertices of the parallelogram, the base-side parallel link 86 and the intermediate coupling portion 83 move with the rotation supports A1, A3, B1, B3 maintaining the parallelogram. Moreover, since the first and fourth intermediate rotation supports B1, B4 and the first and third tip-side rotation supports C1, C3 from the respective vertices of the parallelogram, the tip-side parallel link 87 and the head main body 71 of the head portion 70 move with the rotation supports B1, B4, C1, C3 maintaining the parallelogram.

The rotation supports A1, A3, B1, B3 maintain the parallelogram to keep the orientation of the intermediate coupling portion 83 with respect to the base portion 60 constant. Furthermore, the rotation supports B1, 43, C1, C3 maintain the parallelogram to keep the orientation of the head main body 71 of the head portion 70 with respect to the intermediate coupling portion 83 constant. The above-described two parallelograms keep the orientation of the head main body 71 of the head portion 70 with respect to the base portion 60 constant. In other words, the up-down driving motor 91 is driven to allow the objects W1, W2 to be conveyed in the up-down direction with the head main body 71 of the head portion 70 maintaining a constant orientation with respect to the base portion 60.

Now, operations of the conveying robot 50 will be described with reference to FIG. 1 and FIG. 5. The slide motor 93 is driven to slidably move the whole conveying robot 50 along the rail beams 21, 22 in the first row and the rail beams 26, 27 in the second row. For example, the object W1 is conveyed from the position of a first machine tool (not depicted in the drawings) to the position of a second machine tool (not depicted in the drawings).

However, before conveyance, the head main body 71 of the head portion 70 of the conveying robot 50 is raised upward. In other words, the conveying robot 50 is allowed to pass over the machine tool.

When the conveying robot 50 reaches a space above the second machine tool, the up-down driving motor 91 is driven to move the position of the head portion 70 in the up-down direction with respect to the base portion 60.

At this time, with an upper opening in the machine tool open, the head portion 70 holding the object W1 lowers and enters the inside of the machine tool through the opening therein. Therefore, a part of the conveying robot 50 that enters the inside of the machine tool needs to be smaller than the opening width of the opening.

In the conveying robot 50 in the present embodiment, the interior angles of the hexagon at the first and second intermediate rotation supports B1, B2 are each an angle of less than 180° as described above. Accordingly, as can be seen from FIG. 5, the separation distance between the first and second intermediate rotation supports B1, B2 is maximized when the first and second intermediate rotation supports B1, B2 are positioned at the same height as that of the first and second base-side rotation supports A1, A2. In other words, when, in the above-described state, the head portion 70 is moved downward, a problem is a relation between the opening width of the opening in the machine tool and the separation distance between the first driven link 84 and the second driven link 85. This also applies to the separation distance between the tip-side parallel link 87 and the second driven link 85.

As depicted in FIG. 5 and FIG. 7, the first driven link 84 is formed to have a bent shape that protrudes toward the second driven link 85 (the right side of FIG. 5) with respect to a straight line that connects the first intermediate rotation support B1 and the first tip-side rotation support C1. The second driven link 85 is formed to have a bent shape that protrudes toward the first driven link 84 (the left side of FIG. 5) with respect to a straight line that connects the second intermediate rotation support B2 and the second tip-side rotation support C2. As compared to a case where the first driven link 84 and the second driven link 85 are assumed to be linear members, the present configuration reduces the separation distance between a part of the first driven link 84 that is close to the head portion 70 and a corresponding part of the second driven link 85 that is close to the head portion 70.

Moreover, the tip-side parallel link 87 is formed to have a bent shape that protrudes toward the second driven link 85 (the right side of FIG. 5) with respect to a straight line that connects the fourth intermediate rotation support B4 and the third tip-side rotation support C3. This configuration reduces the separation distance between a part of the tip-side parallel link 87 that is close to the head portion 70 and a corresponding part of the second driven link 85 that is close to the head portion 70.

Therefore, even if the width of the upper opening in the machine tool is small, which is a destination to which the conveying robot 50 conveys the object, the head portion 70 can enter the inside of the machine tool. In other words, the width of the upper opening in the machine tool can be reduced, and thus the width dimension of the machine tool can be reduced.

In other words, in the above-described configuration, the up-down driving motor 91 is used to operate the first and second driving links 81, 82 and the first and second driven links 84, 85, allowing the head portion 70 to be quickly inserted into even a machine tool with a small opening width. Moreover, when the head portion 70 moves in the up-down direction, the above-described operation allows a reduction in acceleration and deceleration performed near a lower end of an operating range of the head portion 70. This enables smooth operations of the head portion 70.

Now, forces transmitted by the speed reducer 92 will be described with reference to FIG. 9 and FIG. 10. FIG. 9 and FIG. 10 are schematic diagrams and do not illustrate all of the components of the conveying robot 50.

As depicted in FIG. 9, when the up-down driving motor 91 is driven and it is assumed that a rotation driving force obtained by multiplying the rotational driving force of the up-down driving motor 91 by the speed reduction ratio is 1, a force transmitted from the worm 92a to the first worm wheel 92b and a force transmitted from the worm 92a to the second worm wheel 92c are each 0.5. In other words, when the link mechanism 80 is normally operated by the up-down driving motor 91, the force transmitted between the worm 92a and the first and second worm wheels 92b, 92c is approximately half the driving force of the up-down driving motor 91. This is because the two worm wheels 92b, 92c mesh with the single worm 92a.

Now, a laterally uneven external force is assumed to act on the link mechanism 80 or the head portion 70 as depicted in FIG. 10. For example, an upward impact force F is assumed to be externally applied to the first driving link 81 at a position near the first intermediate rotation support B1. This corresponds to a case where the conveying robot 50 collides, during operation, against an external object. The first driving link 81 then acts to rotate clockwise, in FIG. 10, about the first base-side rotation support A1. In other words, the rotational driving force of the first worm wheel 92b provided integrally with the first driving link 81 is transmitted to the worm 92a.

In this case, as described above, the self-lock does not act on the speed reducer 92. Therefore, the worm 92a rotates when motive power is transmitted from the first worm wheel 92b to the worm 92a in conjunction with rotation of the first worm wheel 92b. Here, the up-down driving motor 91 is assumed to permit rotation of the output shaft when a rotational force is externally input to the output shaft. Therefore, rotation of the worm 92a rotates the output shaft of the up-down driving motor 91. As described above, when the first driving link 81 or the like is externally subjected to the impact force F, the worm 92a rotates to reduce a load on meshed teeth of the first worm wheel 92b and the worm 92a. Therefore, the life of the meshed teeth is prolonged.

As depicted in FIG. 10, when the first driving link 81 is externally subjected to the impact force F and it is assumed that the turning force of the first worm wheel 92b is 1, for example, the force transmitted from the first worm wheel 92b to the worm 92a is 1 and the force transmitted from the second worm wheel 92c to the worm 92a is 0. Thus, the turning force of the worm 92a is 1. In other words, the load imposed on the meshed teeth of the first worm wheel 92b and the worm 92a in a case illustrated in FIG. 10 is up to twice as large as the load imposed on meshed teeth of the worm 92a and the first worm wheel 92b in the case illustrated in FIG. 9.

When the self-lock is assumed to act on the speed reducer 92 and the first driving link 81 is subjected to the external impact force F as depicted in FIG. 10, all of the impact force F is absorbed by the meshed teeth of the first worm wheel 92b and the worm 92a. This load is larger in magnitude than a load imposed when a normal operation is performed. Thus, the worm 92a and the first and second worm wheels 92b, 92c need to have enhanced rigidity. However, since the self-lock does not act on the speed reducer 92 as described above, even if a heavy load may be imposed on the meshed teeth, the worm 92a rotates to reduce the load. In other words, even if the teeth of the worm 92a and the first and second worm wheels 92b, 92c do not have high strength or rigidity, the meshed teeth have a prolonged life.

This also applies to a case where the other members of the link mechanism 80 and the head portion 70 is externally subjected to the impact force F. Naturally, the force transmitted from the first worm wheel 92b to the worm 92a and the force transmitted from the second worm wheel 92c to the worm 92a vary depending on a position subjected to the external impact force F.

<Miscellaneous>

In the above-described embodiment, the link mechanism 80 includes the base-side parallel link 86 and the tip-side parallel link 87 in order to keep the orientation of the head portion 70 constant. Alternatively, another orientation maintaining means may be used.

Furthermore, in the above-described embodiment, the upper flanges 114b, 114c of the upper end member 114 include the inclined surfaces 114b1, 114c1, and the lower flanges 214, 215 of the rail beam 21 include the inclined surfaces 214a, 215a. Alternatively, one of the upper end member 114 and the rail beam 21 may have an inclined surface, whereas the other may have a level surface. This is also sufficiently effective.

Furthermore, in the above-described embodiment, the first and second driven links 84, 85 are formed to have bent shapes. However, one of the first and second driven links 84, 85 may have a bent shape, whereas the other may have a linear shape. This case, as compared to a case where both driven links have linear shapes, is also sufficiently effective. In addition, in the above-described embodiment, the single up-down driving motor 91 drives the first and second driving links 81, 82. However, two up-down driving motors may be installed to independently drive the first and second driving links 81, 82, respectively.

### DESCRIPTION OF THE REFERENCE NUMERALS

10: base stand portion, 11, 12: pillars, 21, 22, 26, 27: rail beams, 31 to 38: coupling members for pillars and beams (first and second coupling members), 31a, 31b, 32a, 32b: edges, 41 to 44: coupling members used between beams (third coupling members), 50: conveying robot (moving body), 60: base portion, 70: head portion, 71: head main body, 80: link mechanism, 81: first driving link, 82: second driving link, 83: intermediate coupling portion, 84: first driven link, 85: second driven link, 86: base-side parallel link, 87: tip-side parallel link, 90: driving apparatus, 91: up-down driving motor (rotational driving source), 92: speed reducer (transmission apparatus), 92a: worm, 92b: first worm wheel, 92c: second worm wheel, 93: slide motor, 100: conveying apparatus, 113, 123: main body portion, 114, 115, 124, 125: upper end members, 114a: main body portion (pillar main body portion), 114b, 114c: upper flanges (pillar flanges), 114b1, 114c1: inclined surfaces, 211: beam main body portion, 214, 215: lower flanges (beam flanges), 214a, 215a: inclined surfaces, A1: first base-side rotation support, A2: second base-side rotation support, A3: third base-side rotation support, B1: first intermediate rotation support, B2: second intermediate rotation support, B3: third intermediate rotation support, B4: fourth intermediate rotation support, C1: first tip-side rotation support, C2: second tip-side rotation support, C3: third tip-side rotation support, W1, W2: objects

1. A conveying robot comprising:
a base portion;
a head portion enabled to hold an object;
a first driving link supported so as to be rotatable about a first base-side rotation support on the base portion;
a first driven link supported so as to be rotatable about a first intermediate rotation support on the first driving link and supported so as to be rotatable about a first tip-side rotation support on the head portion;
a second driving link supported so as to be rotatable about a second base-side rotation support on the base portion;
a second driven link supported so as to be rotatable about a second intermediate rotation support on the second driving link and supported so as to be rotatable about a second tip-side rotation support on the head portion; and
a driving apparatus provided on the base portion to rotationally drive the first driving link and the second driving link with respect to the base portion to change a position of the head portion with respect to the base portion, wherein
the conveying robot has at least one of:
a characteristic that the first driven link is formed to have a bent shape that protrudes toward the second driven link with respect to a straight line that connects the first intermediate rotation support and the first tip-side rotation support, and a characteristic that the second driven link is formed to have a bent shape that protrudes toward the first driven link with respect to a straight line that connects the second intermediate rotation support and the second tip-side rotation support.

2. The conveying robot according to claim 1, further comprising:
an intermediate coupling portion supported so as to be rotatable about the first intermediate rotation support with respect to the first driving link and supported so as to be rotatable about the first intermediate rotation support with respect to the first driven link;
a base-side parallel link supported so as to be rotatable about a third base-side rotation support on the base portion and supported so as to be rotatable about a third intermediate rotation support on the intermediate coupling portion, the base-side parallel link being provided in parallel with the first driving link; and
a tip-side parallel link supported so as to be rotatable about a fourth intermediate rotation support on the intermediate coupling portion and supported so as to be rotatable about a third tip-side rotation support on the head portion, the tip-side parallel link being provided in parallel with the first driven link.

3. The conveying robot according to claim 2, wherein
the tip-side parallel link is formed to have a bent shape that protrudes toward the second driven link with respect to a straight line that connects the fourth intermediate rotation support and the third tip-side rotation support.

4. The conveying robot according to claim 1, wherein
the driving apparatus comprises:
one rotational driving source; and
a transmission apparatus that transmits a rotational driving force of the rotational driving source to each of the first driving link and the second driving link.

5. The conveying robot according to claim 4, wherein
the transmission apparatus comprises:
one worm coupled to an output shaft of the rotational driving source or formed integrally with the output shaft;
a first worm wheel attached to the first driving link at the first base-side rotation support to mesh with the worm, and
a second worm wheel attached to the second driving link at the second base-side rotation support to mesh with the worm.

6. The conveying robot according to claim 5, wherein
a lead angle of the worm is set to such a lead angle that allows the worm to rotate when, in conjunction with rotation of at least one of the first worm wheel and the second worm wheel, motive power is transmitted from the worm wheel to the worm.
